(19) United States
(12) Patent Application Publication
(10) Pub. No.: US 2020/0112031 A1
(43) Pub. Date: Apr. 9, 2020

(54) CASCADE ADSORPTION MECHANISM FOR OVERCOMING ACTIVATION ENERGY BARRIER IN OXYGEN REDUCTION REACTION

(71) Applicants: Toyota Motor Engineering & Manufacturing North America, Inc., Plano, TX (US); The University of Akron, Akron, OH (US)

(72) Inventors: Tomoyuki Nagai, Ann Arbor, MI (US); Hongfei Jia, Ann Arbor, MI (US); Zhenmeng Peng, Hudson, OH (US); Xiaochen Shen, Akron, OH (US); Dezhen Wu, Akron, OH (US)

(21) Appl. No.: 16/401,547

(22) Filed: May 2, 2019

Related U.S. Application Data
(60) Provisional application No. 62/742,681, filed on Oct. 8, 2018.

(51) Int. Cl. H01M 4/86; H01M 4/92; H01M 4/90

(52) U.S. Cl. CPC H01M 4/8652; H01M 2004/8689; H01M 4/9016; H01M 4/921

(57) ABSTRACT

Oxygen reduction reaction (ORR) catalyst have particles of a first ORR catalytic material in interspersed contact with particles of a second ORR catalytic material. The first and second ORR catalytic materials have different d band centers so that oxygen can adsorb rapidly at a first binding site, be partly reduced, and then transfer to a second site at which reduction is completed and water desorption is rapid. This allows the catalyst to avoid limitations of slow reactant binding and/or slow product release.

### CROSS-REFERENCE TO RELATED APPLICATIONS

This application claims the benefit of U.S. Provisional Application No. 62/742,681, filed Oct. 8, 2018, incorporated herein by reference in its entirety.

### TECHNICAL FIELD

The present disclosure generally relates to fuel cells and, more particularly, to improved catalysts for an oxygen reduction reaction in fuel cells.

### BACKGROUND

The background description provided herein is for the purpose of generally presenting the context of the disclosure. Work of the presently named inventors, to the extent it may be described in this background section, as well as aspects of the description that may not otherwise qualify as prior art at the time of filing, are neither expressly nor impliedly admitted as prior art against the present technology.

Polymer electrolyte membrane fuel cells (PEMFCs) provide power, via production of water from oxygen and hydrogen, for transportation and stationary applications. Catalysts facilitate oxygen reduction reaction (ORR) in PEMFCs. Platinum particles on carbon support (Pt/C) long represented the state-of-the-art in ORR catalyst technology, although multiple platinum alloy particles have been shown to have activity than state-of-the-art Pt/C. Improvement has virtually ceased however, with most active catalyst—single crystalline Pt₃Ni (111)—having been discovered over 10 years ago. In addition, it is generally believed that existing catalysts have approached the theoretical limit of ORR catalyst activity, such that significant additional gains are unfeasible.

Therefore it would be desirable to provide improved ORR catalysts that avoid the barrier limiting the effectiveness of current catalysts.

### SUMMARY

This section provides a general summary of the disclosure, and is not a comprehensive disclosure of its full scope or all of its features.

In some aspects, the present teachings provide a fuel cell. The fuel cell includes an anode contacting hydrogen gas. The fuel cell further includes a cathode in ionic communication with the anode. The cathode contacts oxygen gas and has a catalyst including: (i) nanoparticles of a first catalytic material selected from the group consisting of: metal oxide and reducible metal ion complex; and (ii) nanoparticles of a second ORR catalytic material, in interspersed contact with the particles of the first catalytic material, and comprising platinum alloy having a formula Ptₓ(CuNi)₁₀₀₋ₓ, wherein 0<x<100.

In other aspects, the present teachings provide a method for making a fuel cell catalyst. The method includes a step of placing particles of a first ORR catalytic material, having a first d band center, on a conductive support, the first ORR catalytic material selected from the group consisting of: metal oxide and reducible metal ion complex. The method further includes a step of positioning particles of a second ORR catalytic material, having a second d band center, in interspersed contact with the particles of the first ORR catalytic material, the second ORR catalytic material comprising a platinum alloy having a formula Ptₓ(CuNi)₁₀₀₋ₓ, wherein 0<x<100.

In still further aspects, the present teachings provide a fuel cell catalyst for the oxygen reduction reaction including: (i) nanoparticles of a first catalytic material selected from the group consisting of: metal oxide and reducible metal ion complex; and (ii) nanoparticles of a second ORR catalytic material, in interspersed contact with the particles of the first catalytic material, and comprising platinum alloy having a formula Ptₓ(CuNi)₁₀₀₋ₓ, wherein 0<x<100.

Further areas of applicability and various methods of enhancing the disclosed technology will become apparent from the description provided herein. The description and specific examples in this summary are intended for purposes of illustration only and are not intended to limit the scope of the present disclosure.

### BRIEF DESCRIPTION OF THE DRAWINGS

The present teachings will become more fully understood from the detailed description and the accompanying drawings, wherein:

FIG. 1A is a perspective view of a space-fill model of a catalyst surface, depicting a current understanding of pathways for the oxygen reduction reaction (ORR);

FIG. 1B is a Gibbs Free Energy diagram, showing Gibbs Free Energy as a function of reaction coordinate and showing three activation energies (E_{A1}, E_{A2}, and E_{A3}) corresponding to three steps in a dissociative ORR as catalyzed by three different catalysts having different affinities for oxygen-containing species;

FIG. 1C is a scaling correlation between E_{Ai} (i=1, 2 and 3) and d band center (ε_{d}), and the resultant volcano correlation in a plot of ORR activity vs. ε_{d};

FIG. 2A is a perspective view of a portion of a catalyst of the present teachings, having a particle of a first ORR catalytic material, a reducible metal oxide, in contact with a particle of a second catalytic material, a platinum alloy;

FIG. 2B is a perspective view of a catalyst of the type shown in FIG. 2A, in which the particle of a first active material includes a reducible metal ion complex;

FIG. 3A is a proposed Gibbs Free Energy profile for a catalyst of FIGS. 2A and 2B;

FIG. 3B is a theoretical plot of activation energy E^{Ai} (i=1, 2 and 3) vs. ε_{d}, illustrating how a catalyst of FIG. 2A or 2B can achieve an overall activation energy, E_{A,new}, that is lower than the minimum activation energy, E_{A,min}, considered to be the lowest activation energy attainable by existing catalysts;

FIG. 4A is an electron micrograph of a synthesized catalyst having 20 wt. % platinum nanoparticles on carbon;

FIG. 4B is an electron micrograph of a synthesized catalyst having 20 wt. % platinum-copper alloy nanoparticles on carbon, and illustrating a process for tuning the d band center of the platinum alloy used in a catalyst of FIG. 2A or 2B;

FIG. 4C is an electron micrograph of a synthesized catalyst having 20 wt. % platinum-copper-nickel alloy (Pt₁(CuNi)₁) nanoparticles on carbon, and further illustrating the process for tuning the d band center of the platinum alloy used in a catalyst of FIG. 2A or 2B;

FIG. 4D is an electron micrograph of a synthesized catalyst having 20 wt. % platinum-copper-nickel alloy (Pt₁(CuNi)₂) nanoparticles on carbon, and further illustrating the process for tuning the d band center of the platinum alloy used in a catalyst of FIG. 2A or 2B;

FIG. 5A shows cyclic voltammograms for cells having the catalysts of FIGS. 4C and 4D;

FIG. 5B shows a linear sweep voltammogram for a cell having the catalysts of FIGS. 4C and 4D;

FIG. 5C is a plot of Area-specific ORR current density vs. platinum content in catalyst of the type shown in FIGS. 4C and 4D and having the generic formula Ptₓ(CuNi)₁₀₀₋ₓ;

FIG. 6A is a schematic perspective view of a space fill model of a single particle of an alternative catalyst of the present teachings, having particles of the first ORR catalytic material decorating the surface of a particle of the second ORR catalytic material, where the first particles are of a reducible metal oxide or a reducible metal ion complex, and the second particle is platinum or a platinum alloy;

FIG. 6B shows cyclic voltammograms for catalysts of the type shown in FIG. 6A, where the second active site is a platinum and the first active site is tin oxide, including samples with different tin oxide deposition duration (including zero);

FIG. 6C shows cyclic voltammograms for catalysts of the type shown in FIG. 6A, where the second active site is a Pt₂₀(CuNi)₈₀ and the first active site is tin oxide, including samples with different tin oxide deposition duration (including zero);

FIG. 6D is a plot of Area-specific ORR current density vs. catalyst platinum content in cells having catalysts of the type shown in FIG. 6A where the second active site is formula Ptₓ(CuNi)₁₀₀₋ₓ and the first active site is tin oxide, with different durations of tin oxide deposition (including zero); and

FIG. 6E is a plot of relative change in ORR activity for the catalysts of FIG. 6D.

It should be noted that the figures set forth herein are intended to exemplify the general characteristics of the catalysts of the present technology, for the purpose of the description of certain aspects. These figures may not precisely reflect the characteristics of any given aspect, and are not necessarily intended to define or limit specific embodiments within the scope of this technology. Further, certain aspects may incorporate features from a combination of figures.

### DETAILED DESCRIPTION

The present teachings provide catalysts of the oxygen reduction reaction (ORR) for use in fuel cells, methods for making the catalysts, and fuel cells having such catalysts. The catalysts of the present teachings have improved catalytic activity in comparison to state-of-the-art catalyst and can, in some cases, achieve activation energies lower than the assumed minimum activation energy attainable by state-of-the-art catalysts.

The ORR catalysts of the present teachings include particles of two different types, and having differing oxygen binding affinity to overcome energetic barriers limiting the optimization of traditional catalysts. In one example, a catalyst of the present teachings can include particles of a platinum alloy, surface directed with particles of an additional catalytic composition, such as tin oxide.

When state-of-the-art ORR catalysts are tuned for any property (such as platinum content in an alloy) that affects oxygen binding and catalytic activity (e.g. reaction rate), a plot of catalytic activity vs. the property being tuned will show an increase in activity and then a decrease in activity as the property is progressively adjusted. In effect, increasing the binding affinity and adsorption rate for oxygen and oxygen-containing intermediates will increase catalytic activity, up to a point. Further increases in binding affinity and adsorption rate will decrease the catalytic activity. It is generally understood that this is because catalysts with low oxygen binding affinity will be rate-limited by a slow, initial oxygen (O₂) adsorption step, whereas catalysts with high oxygen binding affinity will be rate-limited a slow, final water desorption step. Thus it is generally believed that ORR catalysts should have a moderate oxygen binding affinity (or, more precisely, a properly balanced d band center (ε_{d})), so that neither reactant adsorption nor product desorption is excessively slow. Similarly, and because of these competing effects of binding affinity, it is generally believed that ORR catalyst have a minimum achievable overall activation energy for the reaction, and thus a maximum achievable reaction rate.

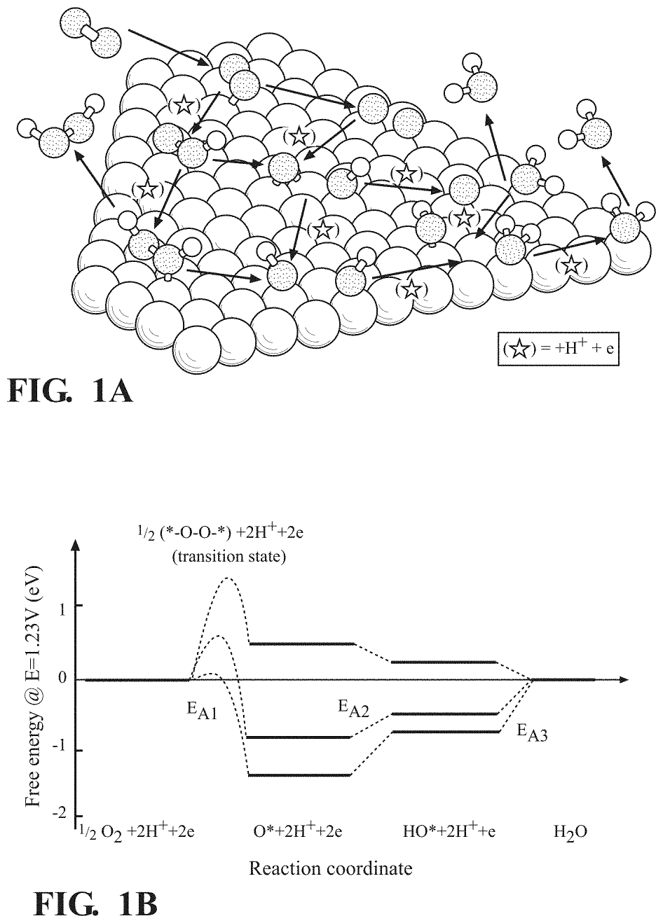

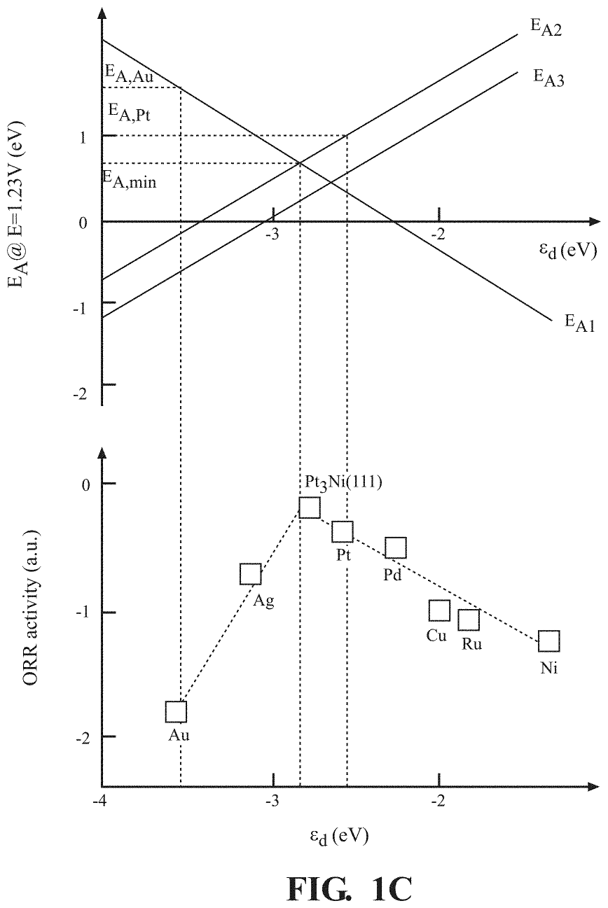

FIG. 1A is a perspective view of a space-fill model of a catalyst surface, depicting a current understanding of pathways for the ORR. In a conventional dissociative mechanism, adsorbed oxygen (depicted with a speckled surface) undergoes immediate dissociation to oxygen radicals prior to reduction and eventual desorption. In an associative mechanism, adsorbed molecular oxygen is first reduced to OOH or HOOH prior to cleavage of the oxygen-oxygen bond, continued reduction, and eventual desorption.

FIG. 1B is a Gibbs Free Energy diagram, showing Gibbs Free Energy as a function of reaction coordinate and showing three activation energies (E_{A1}, E_{A2}, and E_{A3}) corresponding to three steps in a dissociative ORR as catalyzed by three different catalysts having different affinities for oxygen-containing species. E_{A1} corresponds to dissociation of adsorbed O₂; E_{A2} corresponds to initial reduction to OH; and E_{A3} corresponds to subsequent reduction to H₂O.

FIG. 1C is a scaling correlation between E_{Ai} (i=1, 2 and 3) and d band center (ε_{d}), and the resultant volcano correlation in a plot of ORR activity vs. ε_{d}. This illustrates, in a conventional catalyst, existence of an optimum ε_{d} and the limit to overall catalysis due to the opposite kinetic effect that a change in ε_{d} has in different reaction steps.

Catalysts of the present teachings seek to overcome this barrier by utilizing adjacent active sites having different d band centers. The catalysts of the present teachings thus include pluralities of first and second active sites that are adjacent to one another. The first active sites are generally particles or other structures of a first material having a first d band center, and the second active sites are generally particles or other structures of a second material having a second d band center. In some instances, particles of the first material can decorate surfaces of the particles of the second material. It is believed that this arrangement allows for rapid adsorption of molecular oxygen and early reaction step(s) at the first active sites having higher d band center, followed by transfer of oxygen-containing intermediates to the second active sites having lower d band center. It is further believed that later reaction steps can occur at the active sites having lower d band center, followed by rapid product desorption from the lower affinity active sites, thus producing an overall reaction free of the limitation as described above.

In some implementations, a catalyst of the present teachings can have particles of a first ORR catalytic material, having a first d band center, in interspersed contact with particles of a second ORR catalytic material having a second d band center. The phrase “interspersed contact” can mean that a high percentage (e.g. at least 70%, or at least 80%, or at least 90%, or at least 99%) of the particles of the first ORR catalytic material are in contact with at least one particle of the second ORR catalytic material. In some implementations, either or both of the particles of the first and second ORR catalytic materials can be nanoparticles, having a maximum dimension less than 100 nm, or less than 50 nm, or less than 20 nm, or less than 10 nm.

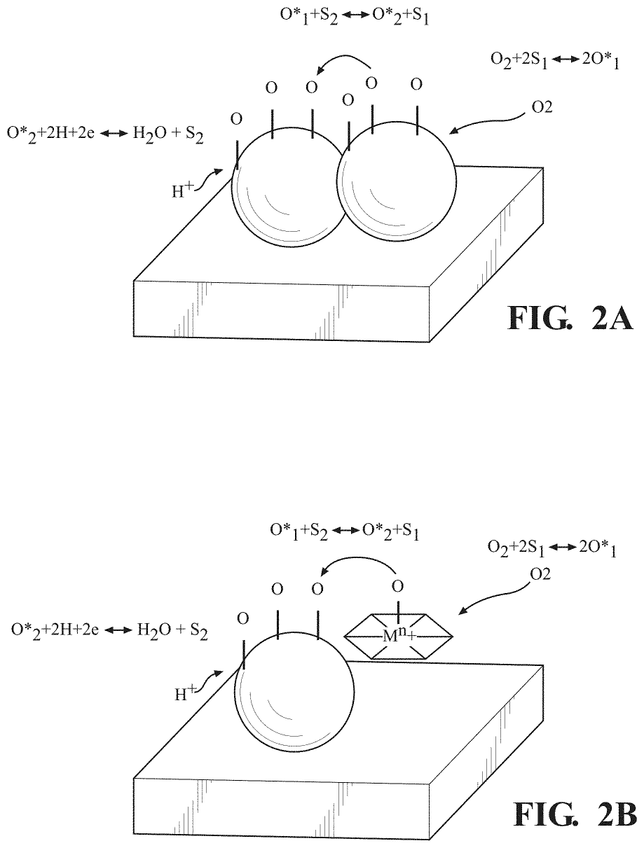

FIG. 2A is a perspective view of a portion of a catalyst of the present teachings, having a particle of a first ORR catalytic material, a reducible metal oxide, in contact with a particle of a second catalytic material, a platinum alloy. The planar surface represents a carbon support, the sphere to the left represents a platinum alloy particle (second catalytic material), and the sphere to the right represents a reducible metal oxide (first catalytic material), such as tin oxide. FIG. 2B is a perspective view of a catalyst of the type shown in FIG. 2A, in which the particle of a first active material includes a reducible metal ion complex, represented by a coordination molecule.

Fuel cells of the present teachings can have an anode in ionic communication with a cathode. In many implementations, the anode can contact hydrogen gas and be in protic communication with the cathode. In many implementations, the cathode can contact oxygen gas, including air or partially or substantially purified oxygen. The cathode includes a catalyst of the type describe above.

Methods for preparing such catalysts can include a step of placing particles of a first ORR catalytic material, having a first d band center, on a conductive support. Such methods can additionally include a step of positioning particles of a second ORR catalytic material, having a second d band center, in interspersed contact with the particles of the first ORR catalytic material. It will be understood that the first and second ORR catalytic materials used in the methods are as described above.

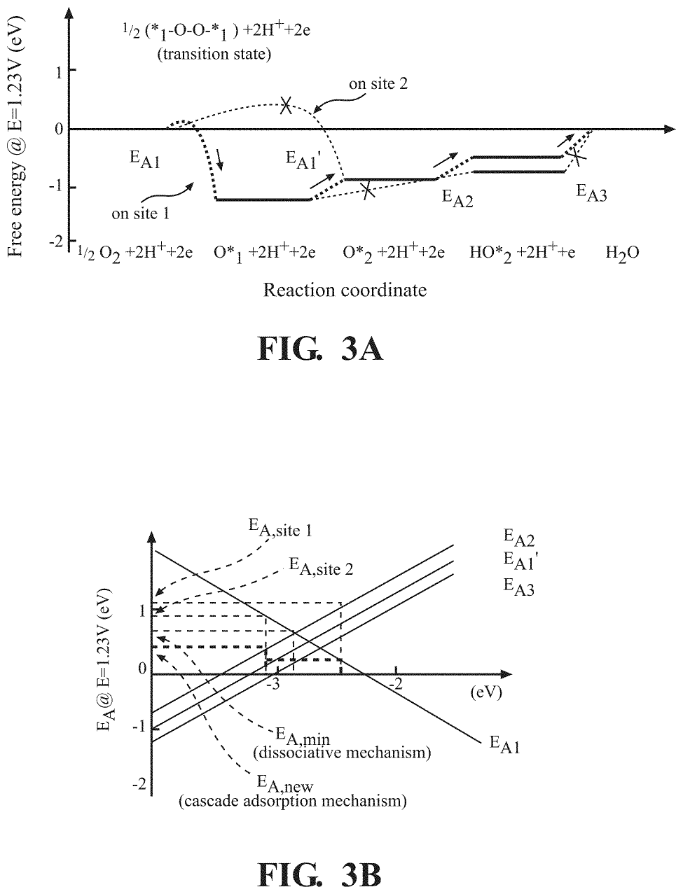

In one aspect, the present teachings provide ORR catalysts based on a new cascade adsorption mechanism, shown in the free energy profile of FIG. 3A. In some such implementations, the catalysts can overcome the E_{A,min} challenge in ORR. The kinetic mechanism shown in FIG. 3A is based on the prospect that adsorbed species can transfer between different active sites, a prospect that is largely overlooked in current ORR mechanisms.

In certain implementations, a catalytic structure that possesses two types of adjacent active sites, O* (e.g. an oxygen radical) that is adsorbed at site one with a lower E_{A1} would be able to transfer to site two with a higher E_{A1} followed by electrochemical reduction (FIG. 3A). It will be understood that the phrase “site one” as used herein can refer to an adsorption site on a particle of the first catalytic material; and that the phrase “site two”, as used herein, can refer to an adsorption site on the on a particle of the second catalytic material; or vice-versa.

In some instances, a particle of the first ORR catalytic material, or a portion thereof, can be referred to alternatively as “active site one.” Similarly, in some instances, a particle of the second ORR catalytic material, or a portion thereof, can be referred to alternatively as “active site two.” Such a cascade adsorption pathway would allow E_{A}<E_{A,min} when the two active sites (e.g. site one and site two) have balanced E_{Ai} values, as shown in FIG. 3B. This mechanism can break the E_{A,min} restriction imposed by the kinetic mechanisms of current structures, and allow a significant decrease in E_{A}.

To verify effectiveness of this new cascade adsorption mechanism, integrated computational simulations and confirmation experiments are employed, including density functional theory (DFT) calculations-aided design of catalytic structure, synthesis and characterizations of selected structure, and catalyst testing to assess the ORR activity property.

It is to be understood that suitably designed catalytic structures are amendable to experimental synthesis, and testing of the cascade adsorption mechanism. Catalytic structures in which Pt alloy/reducible metal oxide and Pt alloy/reducible metal complex heterojunctioned catalytic structures both employed (FIGS. 2A and 2B). In many implementations, particles of the second ORR catalytic material can be formed of or include a platinum-containing alloy, such as an alloy of platinum and copper, or an alloy of platinum, copper, and nickel. In many implementations, particles of the first ORR catalytic material can include reducible oxides (e.g. TiO₂, MnOₓ, SnO_{y}, etc.) and/or reducible metal complexes (e.g. Co(II) complexes). In certain implementations, particles of the first ORR catalytic material can include any metal oxide and/or any metal complex known to possess oxygen activation and adsorption properties. Pt—Cu alloys can be selected to provide active site two considering their tunable ORR activity property by controlling the alloy composition to adjust ε_{d} (thus E_{Ai}). In some implementations, individual particles of the first ORR catalytic material can be as small as a single molecule of a reducible metal ion complex.

Microkinetic modeling based on the cascade adsorption mechanism suggests the structure of a catalyst of the present teachings preferably has balanced activation energy barriers associated with individual steps (i.e., E_{A1}≈E_{A1′}≈E_{A2}≈E_{A3}). DFT simulations can be used to screen different materials by simulating their E_{Ai} values at E=1.23V, which can help to select the components in both designed catalytic structures with desired material parameters (i.e., metal oxide type, metal complex type, and Pt alloy composition). The DFT computation can be carried out by following known procedures, such as procedures employing GGA PBE function and VASP code. Electrochemical stability of reducible metal oxide and reducible metal complex can be considered for practical purposes during the material selection.

Catalytic structures, such as those guided by DFT calculations, can be synthesized using wet chemistry and characterized for composition and structural confirmation. Pt—Cu alloy nanoparticles with controlled composition can be synthesized. Certain metal oxides and metal complexes can be either synthesized or purchased depending on their availability. Pt—Cu/metal oxide and Pt—Cu/metal complex heterjunctioned structures can be prepared by mixing the component materials to achieve interspersed contact, which can be followed by their loading to carbon or other suitable support material. The synthetic procedures and parameters can be subject to modifications in order to realize both good Pt alloy-metal oxide and Pt alloy-carbon contacts in the Pt—Cu/metal oxide structure and sufficient metal complex decoration on Pt—Cu surface and in the meantime effective Pt alloy surface exposure in the Pt—Cu/metal complex structure.

A combination of techniques can be used to evaluate quality of the synthesized materials and characterize their structural parameters, which can include TEM and PXRD for particle size, uniformity, and phase information, HRTEM for structure information, AA for metal loading, and chemisorption for active surface area measurement.

Synthesized catalysts of the present teachings can be tested to determine the ORR activity property to demonstrate the cascade adsorption mechanism. The cascade adsorption can be examined by comparative XPS characterization of Pt alloy/metal oxide, Pt alloy/metal complex, and Pt alloy materials after oxygen exposure. Whether Pt surface oxidation status is altered can serve as a useful measure of adsorbed oxygen species transfer between active sites. Area-specific ORR current density can be measured by running linear sweep voltammetry and normalization using catalyst active surface determined by HUPD and CO stripping methods, which can be used to evaluate the intrinsic catalyst activity. Kinetic electrochemistry experiments can be carried out by systematically adjusting O₂ partial pressure, proton concentration, and electrode potential in the kinetics-controlled region to eliminate diffusion effects. The data can be used for rate law derivation and evaluation of E_{A} value at E=1.23 V. The determined rate law and E_{A} values for the Pt alloy/metal oxide and Pt alloy/metal complex can be compared to those for a comparative Pt alloy (having no associated particles of a first ORR catalytic material) to examine effectiveness of the cascade adsorption ORR mechanism.

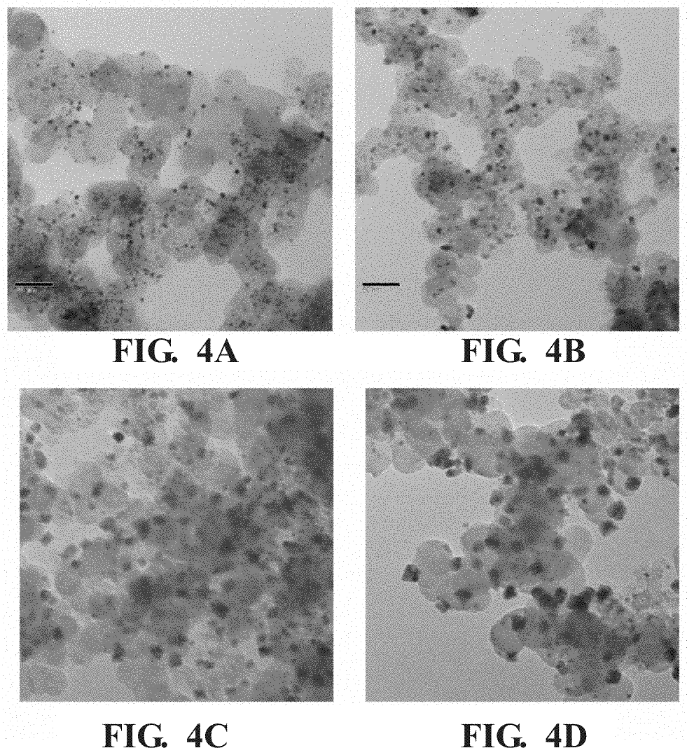

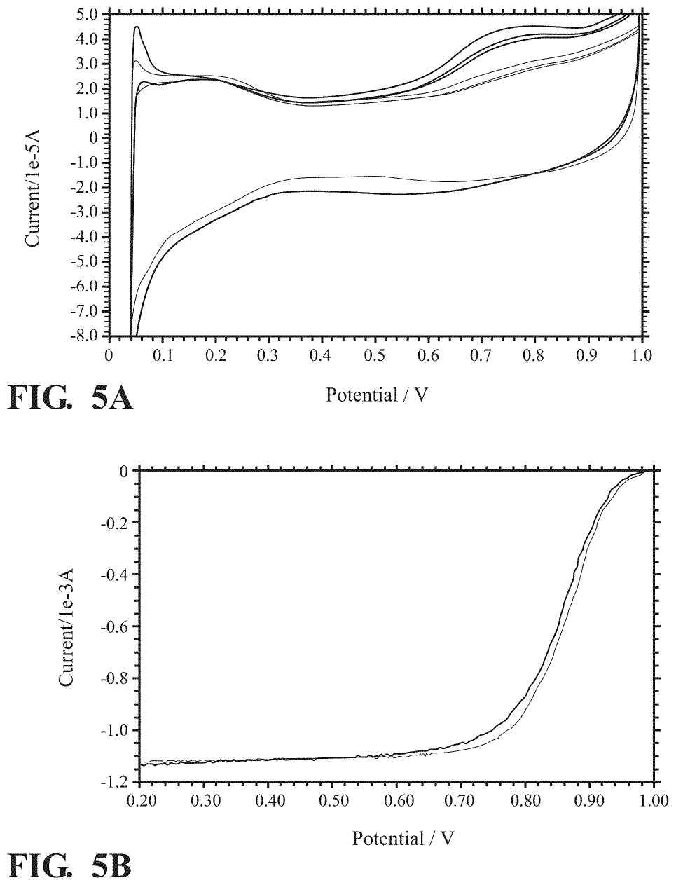

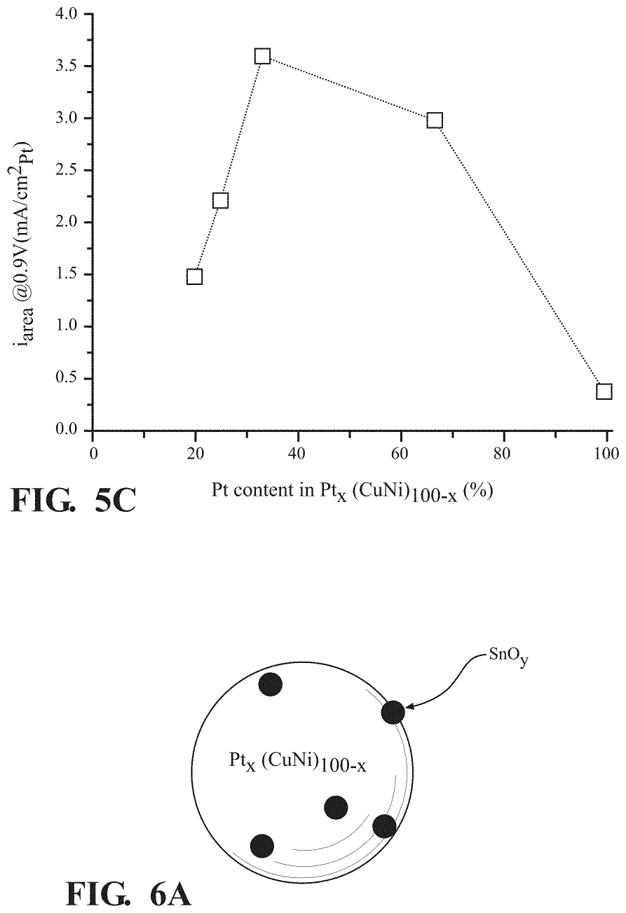

FIGS. 4A-4D and 5A-5C show various efforts at optimizing the composition of the second catalytic material. FIGS. 4A-4D show electron micrographs of various compositions, representing alternatives for the second ORR catalytic material. FIG. 4A is an electron micrograph of a synthesized catalyst having 20 wt. % platinum nanoparticles on carbon; FIG. 4B is an electron micrograph of a synthesized catalyst having 20 wt. % platinum-copper alloy nanoparticles on carbon; FIG. 4C is an electron micrograph of a synthesized catalyst having 20 wt. % platinum-copper-nickel alloy (Pt₁(CuNi)₁) nanoparticles on carbon; and FIG. 4D is an electron micrograph of a synthesized catalyst having 20 wt. % platinum-copper-nickel alloy (Pt₁(CuNi)₂) nanoparticles on carbon. It is observed (data not shown) that with addition of copper only (i.e. PtCu alloys of varying copper content), ORR area-specific activity increased monotonously with Cu content, up to Cu-rich PtCu3. This suggests little possibility to surpass the “volcano top” to reach a preferred d-band center for the second catalyst material. In contrast, PtCuNi alloys exhibit a greater ability to tune d-band center, and represent a preferred choice for the second catalyst material.

FIGS. 5A and 5B show representative cyclic voltammograms and a linear sweep voltammogram for a cell having an ORR catalyst of Ptₓ(CuNi)₁₀₀, and without a first ORR catalytic material. FIG. 5C is a plot of Area-specific ORR current density vs. platinum content in catalyst of the type shown in FIGS. 4C and 4D and having the generic formula Ptₓ(CuNi)₁₀₀₋ₓ, showing the conventional volcano correlation.

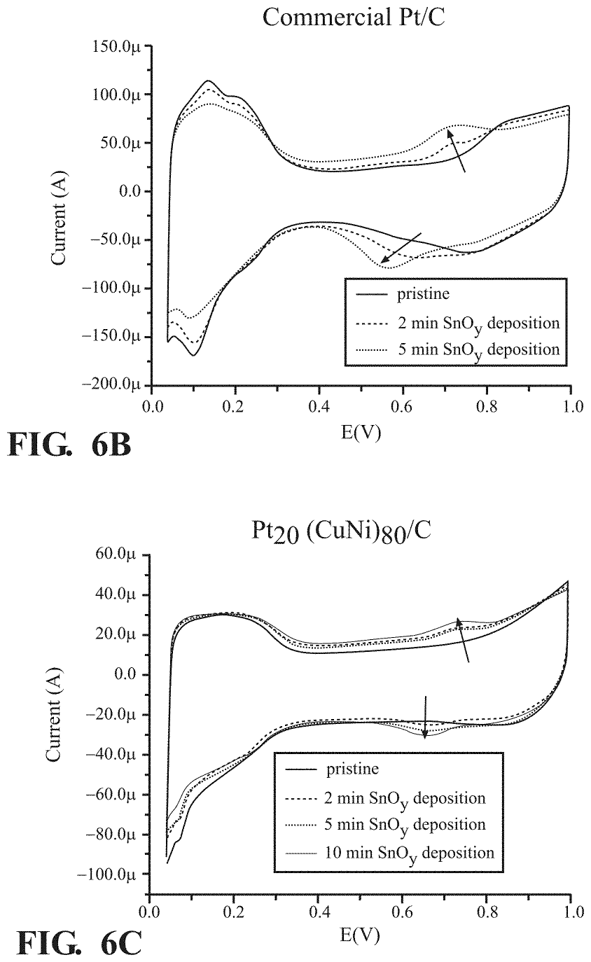

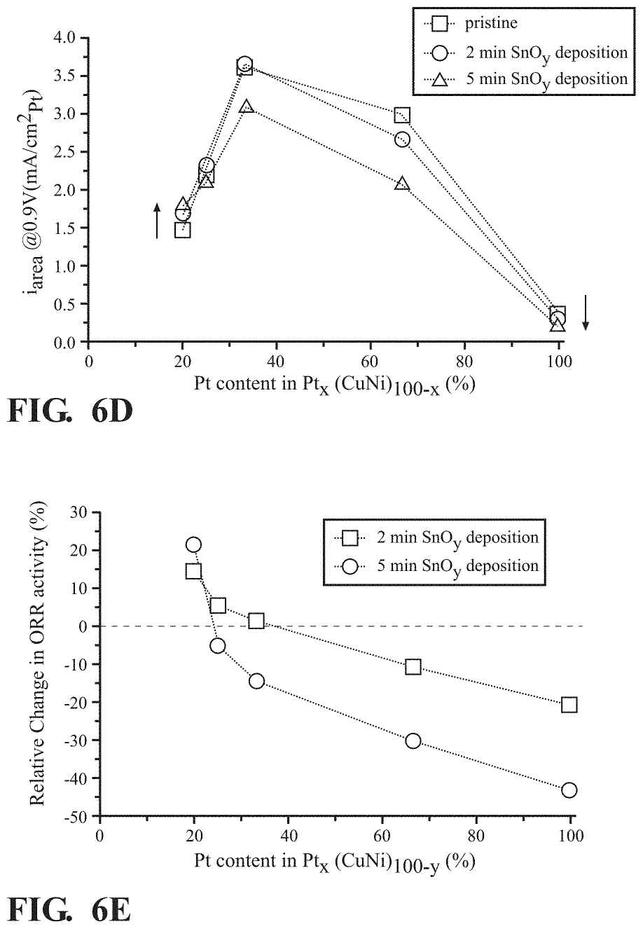

FIG. 6A is a schematic perspective view of a space fill model of a single particle of an alternative catalyst of the present teachings, having particles of the first ORR catalytic material decorating the surface of a particle of the second ORR catalytic material, where the first particles are of a reducible metal oxide or a reducible metal ion complex, and the second particle is platinum or a platinum alloy.

FIGS. 6B-6D show data analogous to those of FIGS. 5A-5C, but for a catalyst of the present teachings. FIG. 6B shows cyclic voltammograms for catalysts of the type shown in FIG. 6A, where the second active site is a platinum and the second active site is tin oxide, including samples with different tin oxide deposition duration (including zero); while FIG. 6C shows analogous cyclic voltammograms for catalysts of the type shown in FIG. 6A, but where the second active site is a Pt₂₀(CuNi)₈₀. FIG. 6D is a plot of Area-specific ORR current density vs. catalyst platinum content in cells having catalysts of the type shown of FIG. 6C. FIG. 6E is a plot of relative change in ORR activity for the catalysts of FIG. 6D.

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure, and are not intended to limit the disclosure of the technology or any aspect thereof. The recitation of multiple embodiments having stated features is not intended to exclude other embodiments having additional features, or other embodiments incorporating different combinations of the stated features.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an embodiment can or may comprise certain elements or features does not exclude other embodiments of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with an embodiment or particular system is included in at least one embodiment or aspect. The appearances of the phrase “in one aspect” (or variations thereof) are not necessarily referring to the same aspect or embodiment. It should be also understood that the various method steps discussed herein do not have to be carried out in the same order as depicted, and not each method step is required in each aspect or embodiment.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations should not be regarded as a departure from the disclosure, and all such modifications are intended to be included within the scope of the disclosure.

What is claimed is:

1. A fuel cell comprising:
an anode contacting hydrogen gas; and
a cathode in ionic communication with the anode, the cathode contacting oxygen gas and having a catalyst comprising:
nanoparticles of a first ORR catalytic material selected from the group consisting of: metal oxide and reducible metal ion complex; and
nanoparticles of a second ORR catalytic material, in interspersed contact with the nanoparticles of the first ORR catalytic material, the second ORR catalytic material comprising a platinum alloy having a formula Ptₓ(CuNi)₁₀₀₋ₓ, wherein 0<x<100.

2. The fuel cell as recited in claim 1, wherein the first ORR catalytic material has a first d band center, and the second ORR catalytic material has a second d band center that is lower than the first d band center.

3. The fuel cell as recited in claim 1, wherein the first ORR catalytic material comprises metal oxide.

4. The fuel cell as recited in claim 1, wherein the first ORR catalytic material comprises a reducible metal ion complex.

5. The fuel cell as recited in claim 1, wherein the first ORR catalytic material comprises tin oxide.

6. The fuel cell as recited in claim 1, wherein nanoparticles of the first ORR catalytic material decorate surfaces of the nanoparticles of the second ORR catalytic material.

7. The fuel cell as recited in claim 1, wherein at least 70% of the nanoparticles of the first ORR catalytic material are in contact with at least one particle of the second ORR catalytic material.

8. The fuel cell as recited in claim 1, wherein at least 99% of the nanoparticles of the first ORR catalytic material are in contact with at least one particle of the second ORR catalytic material.

9. The fuel cell as recited in claim 1, wherein either or both of the nanoparticles of the first and second ORR catalytic materials have a maximum dimension of less than 20 nm.

10. A method for making a fuel cell catalyst, the method comprising:
placing particles of a first ORR catalytic material, having a first d band center, on a conductive support, the first ORR catalytic material selected from the group consisting of: metal oxide and reducible metal ion complex; and
positioning particles of a second ORR catalytic material, having a second d band center, in interspersed contact with the particles of the first ORR catalytic material, the second ORR catalytic material comprising a platinum alloy having a formula Ptₓ(CuNi)₁₀₀₋ₓ, wherein 0<x<100.

11. The method as recited in claim 10, wherein the first ORR catalytic material has a first d band center, and the second ORR catalytic material has a second d band center that is lower than the first d band center.

12. The method as recited in claim 10, wherein the first ORR catalytic material comprises metal oxide.

13. The method as recited in claim 10, wherein the first ORR catalytic material comprises a reducible metal ion complex.

14. The method as recited in claim 10, wherein the first ORR catalytic material comprises tin oxide.

15. The method as recited in claim 10, wherein particles of the first ORR catalytic material decorate surfaces of the particles of the second ORR catalytic material.

16. The method as recited in claim 10, wherein at least 70% of the particles of the first ORR catalytic material are in contact with at least one particle of the second ORR catalytic material.

17. The method as recited in claim 10, wherein at least 99% of the particles of the first ORR catalytic material are in contact with at least one particle of the second ORR catalytic material.

18. The method as recited in claim 10, wherein either or both of the particles of the first and second ORR catalytic materials are nanoparticles, having a maximum dimension less than 20 nm.

19. A fuel cell catalyst for an oxygen reduction reaction, the fuel cell catalyst comprising:
nanoparticles of a first ORR catalytic material selected from the group consisting of: metal oxide and reducible metal ion complex; and
nanoparticles of a second ORR catalytic material, in interspersed contact with the nanoparticles of the first ORR catalytic material, the second ORR catalytic material comprising a platinum alloy having a formula Ptₓ(CuNi)₁₀₀₋ₓ, wherein 0<x<100.

20. The fuel cell catalyst as recited in claim 19, wherein the first ORR catalytic material has a first d band center, and the second ORR catalytic material has a second d band center that is lower than the first d band center.
